(19) United States
(12) Patent Application Publication
(10) Pub. No.: US 2022/0288651 A1
(43) Pub. Date: Sep. 15, 2022

(54) Hydro Auger Post Hole Cleaner System

(71) Applicants: Shannon Walker, Boerne, TX (US); Ryan Queck, Helotes, TX (US); Remington Walker, Boerne, TX (US)

(72) Inventors: Shannon Walker, Boerne, TX (US); Ryan Queck, Helotes, TX (US); Remington Walker, Boerne, TX (US)

(21) Appl. No.: 17/675,300

(22) Filed: Feb. 18, 2022

Related U.S. Application Data
(60) Provisional application No. 63/159,179, filed on Mar. 10, 2021.

(51) Int. Cl. B08B 3/04; E21B 7/02

(52) U.S. Cl. CPC B08B 3/04; E21B 7/027; B08B 2203/0223; B08B 2203/0247; B08B 2203/027

(57) ABSTRACT

The present invention relates to a hydro auger post hole cleaner. The invention allows for more efficient removal of residual debris from auger-drilled holes. The system can be combined with augers incorporated into engine-mounted machines such as, but not limited to, skid steers, pressure diggers, backhoes and crane diggers. The system uses a toggle-operated pump powered by the machine's battery and controlled with a relay and switch to pump water from water tanks through a water hose to the drill auger on the engine-mounted machine's arm and into an auger-drilled hole. Water causes the debris in the hole to conglomerate and adhere to the auger. The auger is removed from the hole and the adhered conglomeration is removed from the auger, thereby, removing debris from the hole without manual effort.

### CROSS-REFERENCE TO RELATED APPLICATION

The present application claims priority to, and the benefit of, U.S. Provisional Application No. 63/159,179, which was filed on Mar. 10, 2021, and is incorporated herein by reference in its entirety.

### FIELD OF THE INVENTION

The present invention relates generally to the field of drilling augers. More specifically, the present invention relates to a hydro auger post hole cleaner system for clearing debris and dust from drilled holes. The system is comprised of an engine-powered machine equipped with an auger, at least one water tank, an internal hose fluidly connecting the water tanks to a toggle-operated pump powered by the machine's battery via a relay and a cab switch, and a hose pipe connecting the water tanks to the drill auger. While the auger is in a hole, a user activates the pump system to distribute water onto the auger and into the hole. The water causes the dirt, rock, dust and other debris to conglomerate into a muddy mixture that subsequently sticks to the drill auger as it turns in the hole. The auger, along with the conglomerated muddy mixture, can then be removed from the hole where the muddy mixture is easily cleaned off the auger. Accordingly, the present disclosure makes specific reference thereto. Nonetheless, it is to be appreciated that aspects of the present invention are also equally applicable to other like applications, devices and methods of manufacture.

### BACKGROUND

By way of background, an auger is a spiral-shaped tool used for drilling holes in a ground surface that contains soil, rocks and other surfaces or materials. Augers are designed and used for many purposes, but all augers will have a spiral screw with a blade at the cutting end which is known as a “fighting”. As the auger rotates, the flighting scrapes and cuts through the ground and the blades of the auger carry or siphon out the drilled materials. In this manner, augers save time and labor that would otherwise be needed to manually dig a hole with a shovel or post hole digger.

However, when a hole is drilled in the ground using an auger, some of the debris is not removed from the hole, resulting in a residual amount of dust, dirt and other debris in the hole. The debris remaining in the hole reduces the quality and utility of the hole, such that efforts must be made to remove this residual debris from the hole to create a better-quality hole with more utility.

Current hole-cleaning methods and devices require extensive effort and manual labor to remove dirt and debris from the drilled holes. An operator may climb into the drilled hole to clean the hole using a small shovel or his or her hands. Some operators may use a manual post hole digger to clear the debris to avoid climbing into the hole. In some cases, multiple operators may be needed to clear the debris from the holes. The activities associated with these efforts are often unsafe and are time-consuming and inefficient.

Therefore, there exists a long-felt need in the art for a post hole cleaner that eliminates the need to manually clean debris from auger-drilled holes. There also exists a long-felt need in the art for a post hole cleaner that eliminates the need for an operator to climb into an auger-drilled hole or for an operator to request the assistance of others to clean an auger-drilled hole. Further, there is a long-felt need in the art for a post hole cleaner that can be attached to an engine-powered machine such as a skid steer, pressure digger, backhoe, crane digger or other similar machines that are equipped with an auger. Finally, there is a long-felt need in the art for a post hole cleaner that improves the safety and efficiency of removing debris from auger-drilled holes.

The subject matter disclosed and claimed herein, in one embodiment thereof, comprises a hydro auger post hole cleaner system. The system is attached to an engine-powered machine such as a skid steer, pressure digger, backhoe, crane digger or other similar machine that is equipped with an auger. The system features a toggle-operated pump electrically-connected to the battery of the engine-powered machine via a relay and switch. The pump is fluidly-connected to at least one water tank with an internal hose and creates pressure in the at least one tank. A hose pipe is fluidly-connected with the water tank as a means of delivering the pressurized water to the auger. The switch is electrically-connected with the relay and configured to allow an operator to use the switch to activate the relay, thereby providing electrical power to the toggle-operated pump. After creating a hole with the auger, the addition of pressurized water causes the residual dirt, rock, and debris in the hole to conglomerate into a muddy mixture that adheres to the auger. The auger and the muddy mixture are removed from the hole and the muddy mixture is easily cleaned off the auger. The system uses quick-connect couplers for attaching the internal hose to the water tanks and for attaching the hose pipe to the water tanks and the auger. In this manner, the novel post hole cleaner system of the present invention accomplishes all of the forgoing objectives and provides a safe and efficient system to clean debris from holes created by an auger.

### SUMMARY OF THE INVENTION

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hydro auger post hole cleaner system. The system is comprised of a toggle-operated pump connected to an internal battery through a relay switch wherein the battery provides power to a pump to pressurize water in at least one storage tank. A hose pipe is connected to the storage tanks and is configured to supply water to an auger and a hole that is drilled by the auger. The system may use a garden hose pipe, attached to a water source, to resupply water to the tanks when the water in the tanks is exhausted.

In another embodiment of the present invention, the hydro auger post hole cleaner system is combined with an engine-mounted machine, hereafter referred to as a skid steer, wherein an auger is incorporated into the skid steer. The skid steer includes an engine area having a battery and a toggle-operated pump, wherein the battery is connected to the toggle-operated pump through a relay activated by a switch; and a water source area disposed on top of the cab of the skid steer having a pair of water tanks fluidly-connected to the toggle-operated pump with an internal hose pipe. A hose pipe from the pair of water tanks transfers the stored water to an auger that is attached to the skid steer arm. The pump is used for pumping stored water from the water tanks through the hose to the auger and into the hole created by the auger. The water in the hole changes the dry dirt and debris into a muddy conglomerate that sticks to the auger. The auger is then removed from the hole to allow the mud to be removed from the auger, thus cleaning the dirt and debris from the hole.

In further embodiments of the system, the switch is integrated into the dashboard of the skid steer, allowing the operator to activate the pump without leaving his seat in the cabin, and the battery of the skid steer is used to power the toggle operated pump of the integrated post hole cleaner mechanism of the present invention.

In yet another embodiment of the present invention, a method of cleaning dirt and debris from holes drilled in soil or rock via a drill auger attached to a vehicle such as skid steer, pressure digger, back hoe, crane digger or the like engine-mounted machine is disclosed. The method includes using power from the battery to activate a toggle-operated pump to pump the water stored in water tanks mounted on the vehicle through a hose to an auger and into a drilled hole. The hose is connected to the water tanks and the auger with quick connection connections. The released water causes the mixture of dirt, rock and dust to conglomerate into a muddy mixture. The muddy mixture adheres to the auger and can be easily removed from the auger after the auger is removed from the hole.

In yet another embodiment of the present invention, a method of installing a hydro auger post hole cleaner system onto an engine-mounted machine equipped with an auger, such as a skid steer, pressure digger, backhoe or crane digger is disclosed. The method includes installing a pair of water tanks on top of the cabin of the vehicle, installing a toggle-operated pump in the engine area of the engine-mounted machine, connecting a toggle-operated pump with the battery of the engine-mounted machine, connecting the toggle-operated pump to said water tanks, and connecting a hose from said water tanks to the auger. The method further includes connecting a garden hose to said water tanks for refilling the water tanks.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are not intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram showing one potential embodiment of the hydro auger post hole cleaner system of the present invention in accordance with the disclosed architecture;

FIG. 2 illustrates a side perspective view of an exemplary skid steer on which one potential embodiment of the hydro auger post hole cleaner system of the present invention is installed in accordance with the disclosed architecture;

FIG. 3 illustrates a front perspective view of an exemplary skid steer on which one potential embodiment of the hydro auger post hole cleaner system of the present invention is installed in accordance with the disclosed architecture;

FIG. 4 illustrates a perspective view of the engine area of an exemplary skid steer showing connection of the battery, toggle-operated pump, and relay and cab switch in accordance with the disclosed architecture;

FIG. 5 illustrates a flow diagram showing steps performed for installing one potential embodiment of the hydro auger post hole cleaner system of the present invention on an exemplary drilling vehicle in accordance with the disclosed architecture; and

FIG. 6 illustrates a perspective view of the skid steer with one potential embodiment of the hydro auger post hole cleaner system of the present invention installed thereon and in use in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. The figures are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a post hole cleaner that eliminates the manual effort to clean debris out of auger drilled holes. There is also a long-felt need in the art for a post hole cleaner that reduces the time to clear debris out of auger-drilled holes. Additionally, there is a long-felt need in the art for a post hole cleaner that eliminates the need for an operator to climb into an auger-drilled hole to clean debris from the hole. Moreover, there is a long-felt need in the art for an auger-drilled hole cleaner that cleans the hole without the need of additional persons to assist the operator. Further, there is a long-felt need in the art for a post hole cleaner that can be attached to a skid steer, pressure digger, backhoe, crane digger and other similar engine-mounted machines equipped with auger. Finally, there is a long-felt need in the art for an auger-drilled hole cleaner that improves the efficiency of the hole-drilling process.

The subject matter disclosed and claimed herein, in one embodiment thereof, comprises a hydro auger post hole cleaner system. The system is comprised of a toggle-operated pump connected to an internal battery through a relay switch, wherein the battery provides power to a pump, to pump and pressurize water in at least one storage tank. A hose pipe is connected to the storage tanks and is configured to supply water to an auger and a hole that is drilled by the auger. The system may use a garden hose pipe to resupply water to the tanks when the water in the tanks is exhausted. The garden hose pipe may be attached through a quick-connect coupler. The hose pipe connecting the water tanks to the auger may also be attached to the tanks and auger using quick-connect couplers.

In another embodiment, the present invention is exemplified as incorporated into a skid steer to create an integrated auger post hole cleaner combination. The skid steer includes an engine area having a battery, a toggle-operated pump wherein the battery is connected to the toggle-operated pump through a relay and cab switch, a water source area disposed on top of the cabin of the skid steer and having a pair of water tanks connected to the toggle-operated pump using an internal hose pipe, and a hose from the water tanks to an auger attached to the skid steer arm. The pump is used for pumping stored water from the water tanks through the hose to the auger and into the auger-drilled hole.

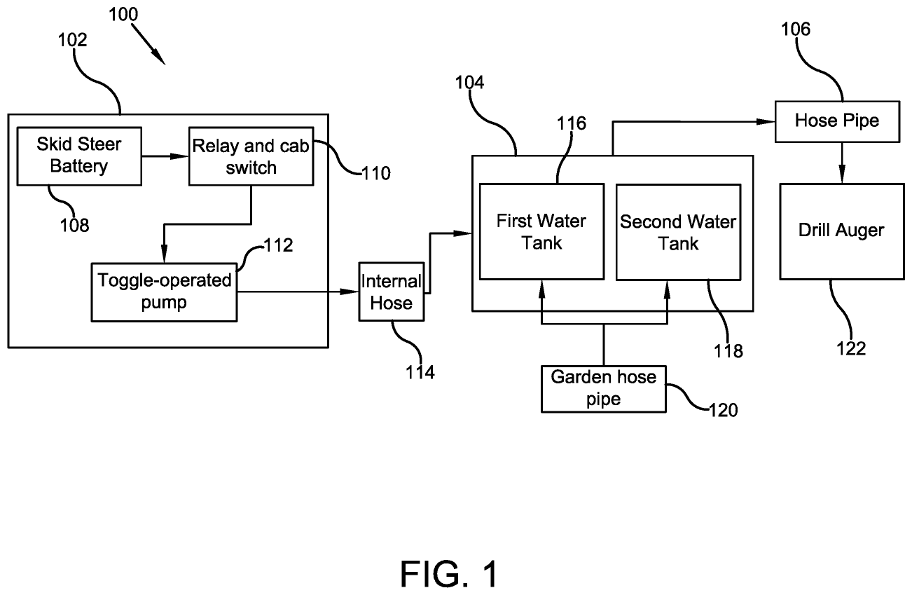

FIG. 1 illustrates a block diagram showing one potential embodiment of the hydro auger post hole cleaner system 100 of the present invention in accordance with the disclosed architecture. The system 100 is designed to be integrated into an engine-powered machine such as a skid steer, a pressure digger, back hoe, crane digger and other similar machines equipped with an auger during the time of manufacturing. The system 100 can also be retrofitted to machinery known in the art. This system 100 is used to clean dirt and debris from auger-drilled holes. More specifically, the system 100 includes components located in the engine area 102, a water source 104 positioned above the cabin of the machinery, and a hose pipe 106 connecting the water source 104 and the auger 122. The system 100 uses the battery 108 of the engine-mounted machine to provide power to a toggle-operated pump 112. The battery 108 is connected to the toggle-operated pump 112 through a relay and cab switch 110. By using the battery 108 of the engine-mounted machine, the system 100 does not require any additional power source and the toggle-operated pump 112 can be operated selectively using the relay and cab switch 110. The relay and cab switch 110 are designed to close and open the connection between the battery 108 and the toggle-operated pump 112. When an operator of the engine-mounted machine activates the toggle-operated pump 112 using the switch and relay 110, the connection between the battery 108 and the toggle operated pump 112 is closed, allowing the battery 108 to provide power to the toggle-operated pump 112. The switch can be disposed on the dashboard (not shown) of such an engine-mounted machine in which the system 100 is installed.

The function of the toggle-operated pump 112 is to pump water from a water source 104 that preferably includes two water tanks; a first water tank 116 and a second water tank 118. The water tanks 116, 118 are fluidly-connected with the toggle-operated pump 112 through an internal hose 114. The internal hose 114 allows the toggle-operated pump 112 to create pressure in the water tanks 116, 118 forcing water to flow through the hose pipe 106 to the auger 122. The water tanks 116, 118 are preferably 25-gallon water tanks to provide enough water to conglomerate the residual soil and debris in the auger-drilled hole, but may be of any size necessary. The hose pipe 106 can be connected to either or both of the water tanks 116, 118. The hose pipe 106 can be detached from one of the water tanks and attached to another water tank. This is useful when the water in one of the tanks 116, 118 is exhausted or if one of the tanks 116,118 becomes damaged. The system 100 also has a garden hose pipe 120 that is used for refilling the water tanks 116, 118. The garden hose pipe 120 is connected with a water source and is detachably-connected to each of the water tanks 116, 118. For attaching the garden hose pipe 120 to the water tanks 116, 118, quick-connect couplers can be used.

The hose pipe 106, connected with quick-connect couplers to the auger 122, transfers water from the storage tanks 116, 118 to the auger 122 and into the auger drilled hole. The water causes the dirt, rock, dust and other residual debris to conglomerate into a muddy mixture that adheres to the drill auger 122. The muddy conglomerate is removed from the hole via the auger 122 and is easily cleaned off the auger 122. In this manner, users can remove residual debris from the auger-drilled hole without asking for assistance, descending into the hole or using a post hole digger to manually remove the residual debris from the auger-drilled hole.

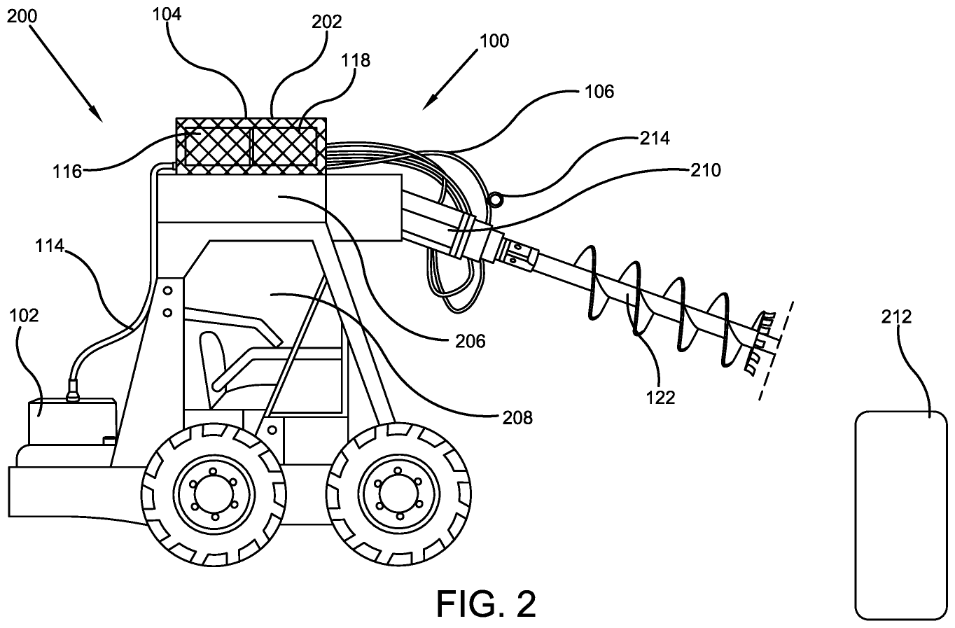

FIG. 2 illustrates a side view of an exemplary skid steer 200 on which the hydro auger post hole cleaner system 100 of the present invention is installed in accordance with the disclosed architecture. As shown, a skid steer 200 has an installed hydro auger post hole cleaner system 100 of the present invention for conglomerating residual debris in an auger-drilled hole 212 and removing the residual debris from the auger-drilled hole 212. The engine area 102 houses the toggle-operated pump 112 connected to the relay switch 110, as seen in FIG. 1. The toggle-operated pump 112 receives power from the skid steer battery 108 housed within the engine area 102. The toggle-operated pump 112 is fluidly-connected to the water tanks 116 118 through a flexible internal hose 114. The water tanks 116, 118 are housed within a water storage area 104. FIG. 2 illustrates the engine area 102 at the rear of the skid steer 200. However, based on the design of the engine-mounted machine or vehicle on which the system 100 of the present invention is installed, the toggle-operated pump 112 and the relay switch 110 can be housed within the engine area located anywhere on the engine-mounted machine.

To provide protection from physical damage, the water tanks 116, 118 in the water source area 104, are positioned above the cabin 208 on the roof 206 and are further protected by a protecting grill 202. The water tanks have an inlet to which the internal hose 114 is connected, allowing the toggle-operated pump 112 to create pressure and move the stored water. Through outlet valves on the water tanks 116, 118, a hose pipe 106 is attached to the skid steer arm 210 with quick-connect couplers. The hose pipe 106 transfers water to the auger 122 and into the hole 212. An operator sitting in the cabin 208 can operate the toggle-operated pump using controls provided on the dashboard of the skid steer 200. The water in the hole 212 combined with the motion of the auger 122 will conglomerate the dirt and debris into a muddy mixture that will adhere to the auger. The operator can then remove the auger 122 from the hole and clean the muddy mixture off the auger. The use of the invention thus eliminates the need for the operator or others to manually clean the debris from the auger-drilled hole 212.

To provide the operator with information on water reserves in the water tanks 116, 118, a water flow meter 214 can be installed in the hose pipe 106 near the attachment of the hose pipe 106 with the skid steer arm 210 in a location visible to the operator. As the water is pumped by the toggle-operated pump 112 from the storage tanks 116, 118 through the hose pipe 106 to the skid steer arm 210 it will pass through the flow meter 214 providing a visual signal to the operator that water is flowing. When water in the storage tanks 116, 118 is exhausted, water will no longer flow through the flow meter 214 and the operator will have an indication that the water supply is exhausted.

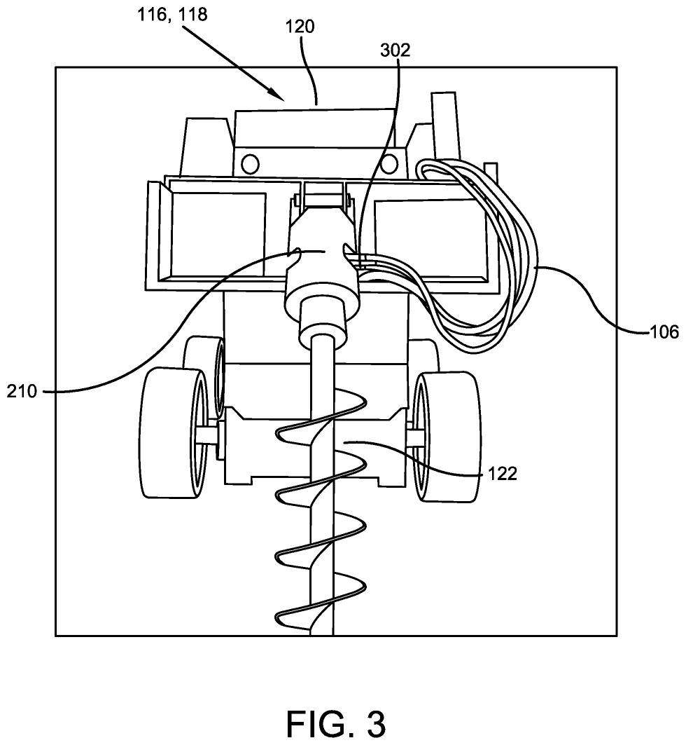

FIG. 3 illustrates a front view of the exemplary skid steer 200 on which the hydro auger post hole cleaner system 100 of the present invention is installed in accordance with the disclosed architecture. As shown, the hose pipe 106 is connected to the drill auger 122 on the skid steer arm 210 using one or more quick-connect couplers 302. The hose pipe 106 is flexible and carries the water from the water tanks 116, 118 to the auger 122. It should be appreciated that since the hose pipe 106 is connected through the couplers 302, the auger 122 and the water tanks 116, 118 are fluidly-connected to each other. Further, as stated earlier, the hose pipe 106 can be connected to any of the water tanks. The quick connect couplers 302 are used because they are designed for easy hand operation along the mobile side arm 210. The couplers 302 can be easily replaced, tightened or loosened without using any tools. The quick connect couplers 302 are sturdy, corrosion resistant and do not damage the hose pipe 106. Also, as shown, the garden hose pipe 120 is also attached to the water tanks 116, 118 for refilling the water in the tanks 116, 118 using quick-connect couplers.

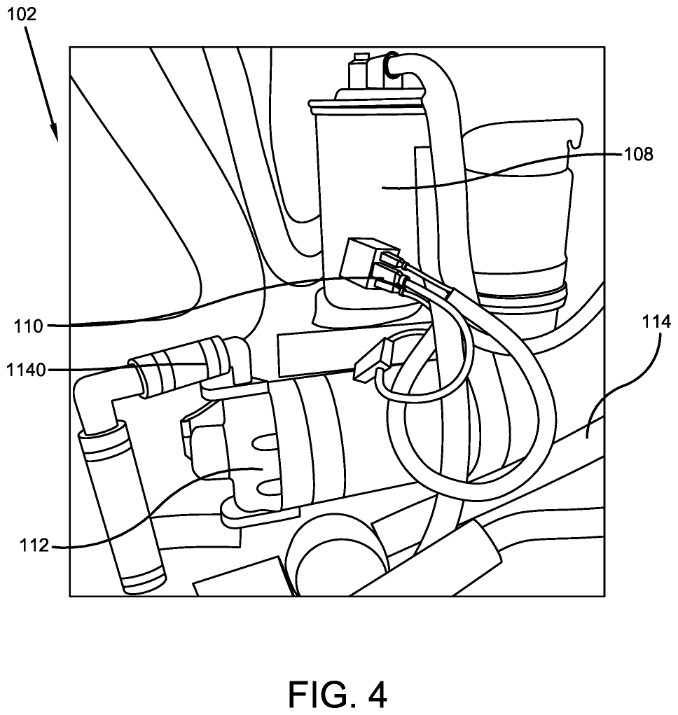

FIG. 4 illustrates a view of the engine area of the exemplary skid steer 200 showing the battery 108, toggle operated pump 112 and relay and cab switch 110 in accordance with the disclosed architecture. The engine area 102 of the exemplary skid steer 200 includes the battery 108 or any other power source electrically-connected to the toggle-operated pump 112 through a relay and cab switch 110. The switch 110 activates the relay to selectively close the electrical connection of the toggle-operated pump 112 with the electric power source 108. Using the connector 1140, the internal hose 114 connects the toggle-operated pump 112 to the water tanks, allowing the toggle-operated pump 112 to pump and pressurize water in the water tanks. The system 100 uses the battery of the machine to provide power to the pump 112. It should be noted that the system of the present invention can be combined with any engine-mounted machine or vehicle to which an auger driller is attached.

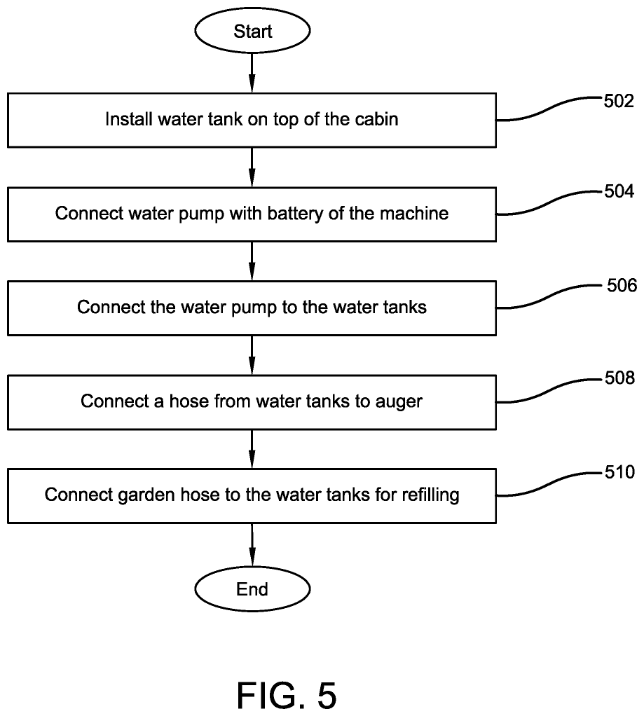

FIG. 5 illustrates a flow diagram showing steps performed to install the hydro auger post hole cleaner system 100 of the present invention on an exemplary engine-mounted machine equipped with a drilling auger in accordance with the disclosed architecture. Initially, water tanks, preferably a pair of water tanks, are placed on the roof of the cabin of the vehicle (Block 502). Then, the toggle-operated pump is installed in the engine area and is connected to the battery of the vehicle through a relay and cab switch 110 (Block 504). Thereafter, the toggle-operated pump is connected with an internal hose pipe 114 (that preferably has a quick connect coupler 302) to the water tanks to allow the tanks to be filled from an external water source and allow the toggle-operated pump to pressurize and pump the water stored in the water tanks (Block 506). For delivering water to the auger and into the hole, a hose connects the water tanks to pump pressure line of the skid steer 200 the auger through the skid steer arm of the vehicle (Block 508). Finally, a garden hose 120 is connected to a water supply and can be used to refill the water tanks (and wherein the hose 120 can be removed once refilling has been completed) when the water supply is exhausted or needed and the cab switch 110 can be used to operate the system 100 (Block 510). It should be noted that once refilling as been completed, the

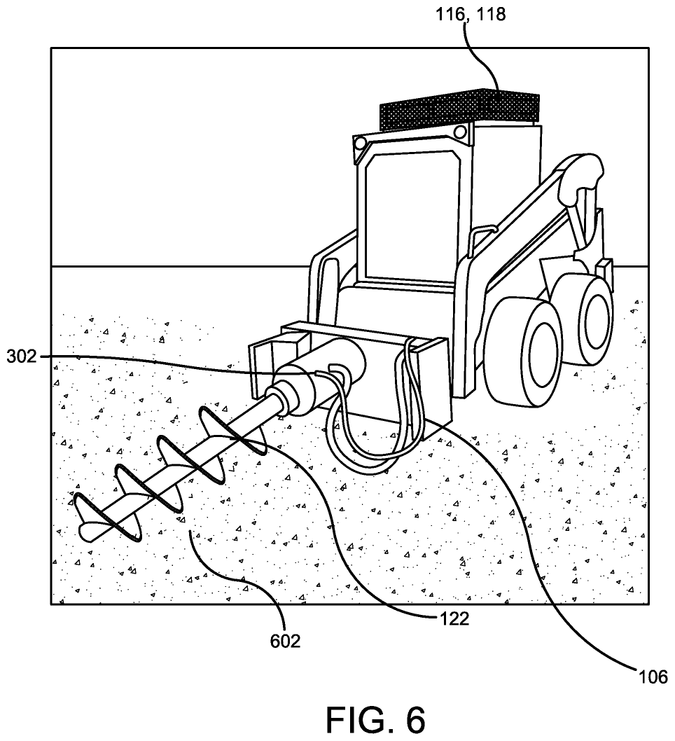

FIG. 6 illustrates the skid steer with the installed hole cleaner system of the present invention in use in accordance with the disclosed architecture. The hose pipe 106 carries water from the water tanks 116, 118 to the auger 122. The hose pipe 106 is attached to the auger 122 using a quick-connect coupler 302 allowing leakage-free transfer of water to the auger 122 and soil 602 around the hole. After drilling a hole with the auger 122, the pump system is activated to distribute water to the auger and into the hole. As the auger is activated in the water-filled hole, the water and the agitation of the auger causes the dirt, rock, dust and debris to conglomerate and turn to mud. The mud adheres to the auger 122. The mud is removed from the hole by removing the auger 122 from the hole. The mud is then easily cleaned off the auger. In this manner, users can remove debris from the auger-drilled hole without asking for assistance, descending into the hole or using post hole diggers to manually remove the debris from the hole.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hydro auger post hole cleaner system”, “hole cleaner system”, “improved post hole cleaner”, “system”, and “cleaner system” are interchangeable and refer to the hydro auger post hole cleaner system 100 of the present invention.

Notwithstanding the forgoing, the hydro auger post hole cleaner system 100 of the present invention can be of any suitable size and configuration as is known in the art without affecting the overall concept of the invention, provided that it accomplishes the above-stated objectives. One of ordinary skill in the art will appreciate that the size, configuration, and material of the hydro auger post hole cleaner system 100 as shown in the FIGS. are for illustrative purposes only, and that many other sizes and shapes of the hydro auger post hole cleaner system 100 are well within the scope of the present disclosure. Although the dimensions of the hydro auger post hole cleaner system 100 are important design parameters for user convenience, the hydro auger post hole cleaner system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner like the term “comprising” as “comprising” is interpreted when employed as a transitional word in a claim.

What is claimed is:

1. A hydro auger post hole cleaner system comprising:
at least one water tank configured to provide a quantity of water;
an internal hose fluidly connected to the at least one water tank;
a toggle operated pump connected to the internal hose and configured to pump the quantity of water and create pressure in the at least one water tank;
a hose pipe fluidly connected to the at least one water tank and configured to deliver the quantity of water to an auger and a hole;
an internal battery configured to power the toggle operated pump;
a relay; and
a switch electrically connected to the relay and configured to activate the relay, wherein the relay is in electrical communication with the internal battery and the toggle operated pump.

2. The hydro auger post hole cleaner system of claim 1, wherein the auger is incorporated into an engine-powered machine having a battery, and further wherein the battery of the engine-powered machine serves as the internal battery to power the toggle operated pump.

3. The hydro auger post hole cleaner system of claim 1, wherein the auger is incorporated into an engine-powered machine having a dash and the switch is incorporated into the dash of the engine-powered machine, and further wherein the switch activates the relay whereby the internal battery and the toggle operated pump are electrically connected.

4. The hydro auger post hole cleaner system of claim 1, wherein the auger is incorporated into an engine-powered machine having a cab, and further wherein the at least one water tank is mounted on the cab of the engine-powered machine.

5. The hydro auger post hole cleaner system of claim 1, wherein the auger is incorporated into an engine-powered machine having an engine area, and further wherein the toggle operated pump is located in the engine area.

6. The hydro auger post hole cleaner system of claim 1, wherein the internal hose connects to the at least one water tank using a quick-connect connection.

7. The hydro auger post hole cleaner system of claim 1, wherein the hose pipe connects to the at least one water tank using a quick-connect connection.

8. The hydro auger post hole cleaner system of claim 1 further comprising a hose connected to a water supply for supplying the at least one water tank with the quantity of water.

9. The hydro auger post hole cleaner system of claim 8, wherein the hose connects to the at least one water tank with a quick connect connection.

10. An auger post hole cleaner combination comprising:
an auger; and
a post hole cleaner comprising:
at least one water tank housing a quantity of water;
an internal hose fluidly connected to the at least one water tank;
a toggle operated pump fluidly connected to the internal hose configured to pump the quantity of water into the at least one water tank and create a pressure in the at least one water tank;
a hose pipe fluidly connected to the at least one water tanks and configured to deliver the quantity of water to the auger;
an internal battery configured to power the toggle operated pump;
a relay; and
a switch electrically connected to the relay and configured to activate the relay, wherein the relay is in electrical communication with the internal battery and the toggle operated pump.

11. The auger post hole cleaner combination of claim 10, wherein the auger is incorporated into an engine-powered machine having a battery, and further wherein the battery of the engine-powered machine is used to power the toggle operated pump.

12. The hydro auger post hole cleaner system of claim 10, wherein the auger is incorporated into an engine-powered machine having a dash and the switch is incorporated into the dash of the engine-powered machine, and further wherein the switch activates the relay whereby the internal battery and the toggle operated pump are electrically connected.

13. The auger post hole cleaner combination of claim 10, wherein the auger is incorporated into an engine-powered machine having an engine area, and further wherein the water pump is located in the engine area.

14. The auger post hole cleaner combination of claim 10, wherein the auger is incorporated into an engine-powered machine having a cab, and further wherein the at least one water tank is mounted on the cab of the engine-powered machine.

15. The auger post hole cleaner combination of claim 10 further comprising a hose having a first end and a second end, wherein the first end is connected to a water source and the second end is connected to the at least one water tank to supply the at least one water tank with the quantity of water.

16. The auger post hole cleaner combination of claim 15, wherein the hose connects to the at least one water tank with a quick connect connection.

17. A method for cleaning a hole created by an auger and the auger, the method comprising the steps of:
activating the auger in the hole, wherein a dirt and debris are conglomerated and adhered to the auger;
removing the auger from the hole;
activating a pump using power from a battery, wherein a quantity of water stored in at least one water tank is pumped through a hose pipe onto the auger and into the hole created by the auger; and
removing the conglomerated dirt and debris adhered to the auger with the quantity of water.

18. The method of claim 17 further comprising a step of using a hose connected to a water source to supply the quantity of water to the at least one water tank.

19. The method of claim 18, wherein the hose connects to the at least one water tank with a quick connect connection.

20. The method of claim 17, wherein the steps of activating and removing are performed by a hydro auger post hole cleaner system comprising the least one water tank, the pump, the battery, a relay and a switch, and further wherein the relay is in electrical communication with the battery and the pump.
